(19) United States
(12) Patent Application Publication
(10) Pub. No.: US 2005/0063390 A1
(43) Pub. Date: Mar. 24, 2005

(54) Method and system for using ATM AAL2 switching within a wireless access gateway

(76) Inventor: Robert J. Nealon, Naperville, IL (US)

Correspondence Address: PATTI & BRILL, ONE NORTH LASALLE STREET, 44TH FLOOR, CHICAGO, IL, 60602, US

(21) Appl. No.: 10/666,600

(22) Filed: Sep. 18, 2003

(51) Int. Cl. H04L 12/56

(52) U.S. Cl. 370/395.6; 370/395.3

(57) ABSTRACT

A method and system provide for using ATM AAL2 switching within a wireless access gateway. In general terms one embodiment of the method has the steps of: providing AAL2 CID (channel identifier) switching in a wireless access gateway, the wireless access gateway having a plurality of transcoders, the plurality of transcoders having a subset of transcoders that are available transcoders; switching a call to any one respective transcoder of available transcoders; and transcoding the call from a first format to a second format in the respective transcoder.

### TECHNICAL FIELD

The present invention relates to wireless telephony in general, and, more particularly, to embodiments of a method and system for using ATM adaptation layer 2 (AAL2) switching within a wireless access gateway.

### BACKGROUND OF THE INVENTION

ATM has been selected as a world standard for broadband ISDN in network communication systems. ATM systems have been implemented on a global basis ATM technology is destined to play a major role in both public and private broadband networks. AAL2 is one of the four types of AAL (ATM Adaptive Layer) protocols which have been recommended by CCITT (now ITU-T), namely AAL1, AAL2, AAL3/4 and AAL5. In general, the layer services provided by AAL1 are constant bit rate (CBR) services, which require information to be transferred between source and destination at a constant bit rate. AAL2 offers a transfer of information with a variable bit rate. In addition, timing information is transferred between source and destination. Since the source is generating a variable bit rate, it is possible that cells are not completely filled and that filling level varies from cell to cell. AAL3/4 is used for transfer of data, which is sensitive to loss, but not sensitive to delay. The AAL3/4 protocol may be used for connection oriented as well as for connectionless data communication. AAL3/4 itself does not perform all functions required by a connectionless service, since functions like routing and network addressing are performed on the network layer. AAL5 is designed to offer a service with less overhead and better error detection below the common part of the convergence sublayer (CPCS).

The AAL2 signaling protocol describes methods by which a switched AAL2 connection can be established between two AAL2 end users across a network that consists of both ATM and AAL2 switches. The current activities in the Study Group 11-WP1/Q6 or ITU-T are focused on specifying the requirements for such a signaling protocol. The important function of AAL2 signaling protocol is to establish an AAL2 connection between two AAL2 end points on a concatenation of ATM Virtual Channel Connections (VCCs) that are either on-demand virtual circuit (SVC—switched virtual circuit) or semi-permanent virtual circuit (PVC—permanent virtual circuit). Some the basic requirements of AAL2 signaling protocol include the ability to establish an AAL2 connection between AAL2 end systems that support AESA (ATM End System Address) formats, the ability to support hop-by-hop routing mechanism between AAL2 end systems, the ability to indicate any failures to corresponding management entity, and the ability to setup AAL2 connections with different QoS requirements.

In AAL2, packets (minicells) from many users are assembled into a single ATM cell and transmitted on the same ATM connection. In addition, packets are allowed to straddle across ATM cell boundary to maximize the bandwidth utilization.

Historically, AAL2 PVCs were dedicated to a single DSP (digital signal processor) used to transcode calls within that PVC. If the transcoder was out of service, this resulted in the PVC also being out of service. This results in a waste of resources, since the PVC is only out of service because the connected transcoder is out of service. In the prior art the entire AAL2 PVC and all its CIDs were initially allocated to transcoder channels at system startup. (It is to be understood that ATM AAL2 and ATM AAL2 CID substantially refer to the same feature in this description.) This resulted in the fixed relationship between the transcoder channels and the external PVCs.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of an embodiment of the present method and system to provide a method and system for using ATM AAL2 switching within a wireless access gateway. In general terms one embodiment of the method has the steps of: providing AAL2 CID (channel identifier) switching in a wireless access gateway, the wireless access gateway having a plurality of transcoders, the plurality of transcoders having a subset of transcoders that are available transcoders; switching a call to any one respective transcoder of available transcoders; and transcoding the call from a first format to a second format in the respective transcoder.

In another embodiment the present method has the steps of: terminating a plurality of external AAL2 PVCs at an intermediate node; setting up a set of internal AAL2 PVCs between the intermediate node and a set of transcoders that form a plurality of DSP (digital signal processor) channels; allocating a respective DSP channel, of the plurality of DSP channels for a call as a function of at least one predetermined parameter; and instructing the intermediate node to switch individual AAL TYPE 2 CPS-packets of the new call from an external AAL2 PVC of the plurality of external AAL2 PVCs to an internal PVC of the set of internal AAL2 PVCs.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of one embodiment of a wireless gateway for use with the present method and system.

FIG. 2 illustrates a very general flow chart of logical operational steps that may be followed in accordance with one embodiment of the present method and system.

FIG. 3 illustrates another flow chart of logical operational steps that may be followed in accordance with one embodiment of the present method and system.

FIG. 4 illustrates yet a further flow chart of logical operational steps that may be followed in accordance with one embodiment of the present method and system.

FIG. 5 illustrates still another flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

With the use of AAL2 CID switching, the individual calls within the AAL2 PVCs can be handled by any transcoder within the Wireless Access Gateway. If the transcoder is out of service, there is no need to remove any PVC from service. The calls within a PVC will be handled by another transcoder within the Wireless Access Gateway.

In one embodiment of the present method, the individual calls within the AAL2 PVCs are distributed to a set of DSPs acting as transcoders for the digital representation of voice. The DSP transcodes the voice encoding from one algorithm into another. In the case of the Wireless Access Gateway, the DSP transcodes from the Adaptive Multi-Rate (AMR) encoding into either the Pulse Code Modulated (PCM, G.711) encoding or the Adaptive Differential Pulse Code Modulated (ADPCM, G.726) encoding. It is to be understood that a single DSP may transcode many channels at a time, and that an individual call through a DSP is called a DSP channel.

In another embodiment, the present method makes use of an intermediate node between the external AAL2 PVCs and the set of transcoders. All external AAL2 PVCs are terminated at this intermediate node. A new set of internal AAL2 PVCs is setup between the intermediate nodes and all possible transcoders. Based upon an algorithm that takes into account the state of the transcoders, the current load on the transcoders, the state of the internal AAL2 PVCs, and other factors the method results in the allocation of a DSP channel for the new call. This method then instructs the new node to switch the individual AAL Type 2 CPS-Packets from an external PVC to an internal PVC.

The differences over the prior art are as follows. An embodiment of the present method allocates the individual CIDs to transcoder channels on an as needed basis such as the initiation of a new call. There is no fixed relationship between the PVCs and the transcoders. As a result maintenance actions may be allowed on either the PVC or the transcoder without affecting the maintenance state of the other. The present method allows for an even distribution of load among the transcoders even if the load on the PVCs is uneven.

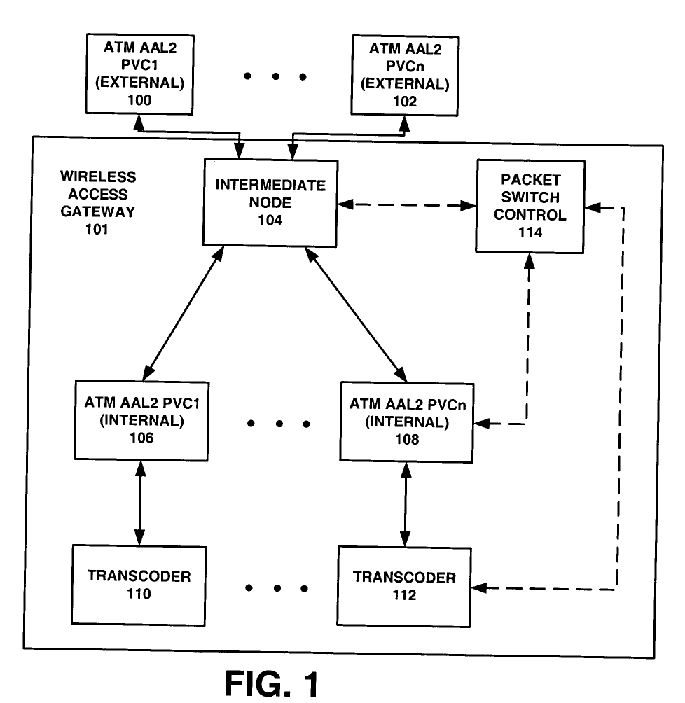

Referring to FIG. 1, external AAL2 PVCs, AAL2 PVC1 (100) . . . to AAL2 PVCn (102), are operatively connected to an intermediate node 104 in a wireless access gateway (101). A set of internal AAL2 PVCs, AAL2 PVC1 (106) . . . to AAL2 PVCn (108), is also operatively connected to the intermediate node 104. Each of the internal AAL2 PVCs is operatively connected thereto a respective transcoder 110 . . . 112. For allocating individual CIDs to transcoder channels on an as needed basis, a packet switch control is operatively connected to the intermediate node 104, the set of internal AAL2 PVCs 106, 108 and the transcoders 110, 112.

Based upon an algorithm that takes into account at least a current state of each of the transcoders 110, 112 and a current load of all of the transcoders, the switch controller instructs the at least one intermediate node to switch individual AAL2 CPS-Packets from the external AAL2 PVCs and to the internal AAL2 PVCs. The set of internal AAL2 PVCs 106, 108 and the set of transcoders 110, 112 form a plurality of DSP channels. The intermediate node 104 switches individual AAL TYPE 2 CPS-packets of a new call, for example, from an external AAL2 PVC of the plurality of external AAL2 PVCs 100, 102 to an internal PVC of the set of internal AAL2 PVCs 106, 108.

The distributing of individual calls to any one respective DSP of available DSPs may be a function of at least one predetermined parameter, the at least one predetermined parameter being at least one of a state of the transcoders, and a current load on the transcoders. The distributing of individual calls to any one respective DSP of available DSPs may be on an as needed basis.

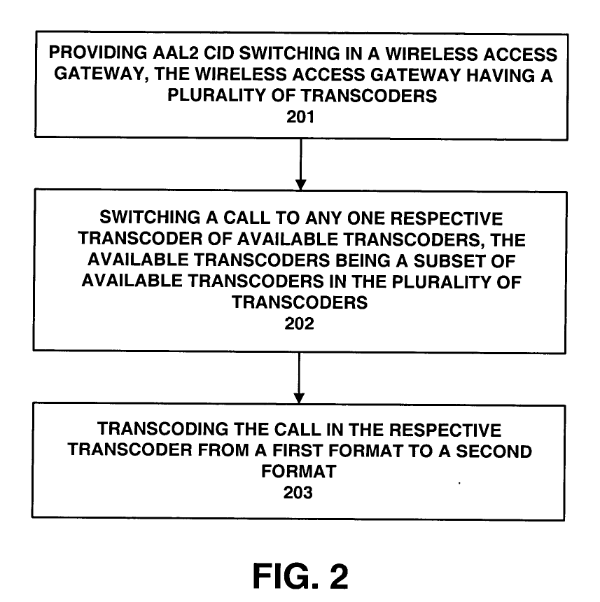

FIG. 2 depicts an embodiment of the present method for using ATM AAL2 switching within a wireless access gateway. This embodiment of the method has the steps of: providing AAL2 CID (channel identifier) switching in a wireless access gateway, the wireless access gateway having a plurality of transcoders, the plurality of transcoders having a subset of transcoders that are available transcoders (step 201); switching a call to any one respective transcoder of available transcoders (step 202); and transcoding the call from a first format to a second format in the respective transcoder (step 203).

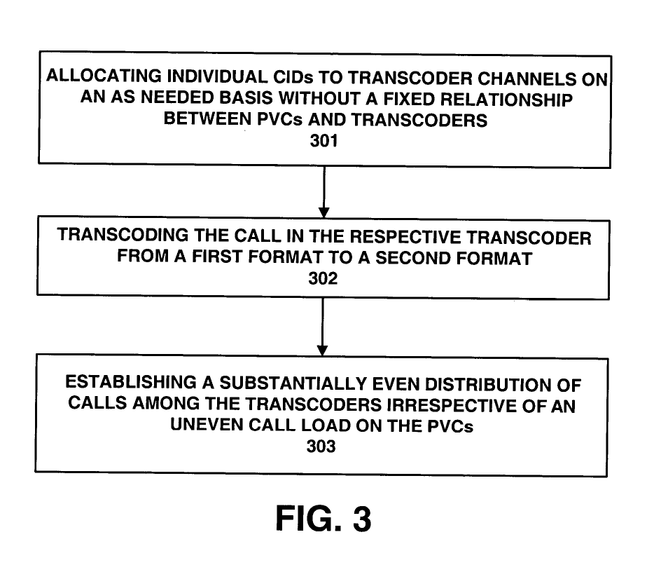

FIG. 3 depicts another embodiment of the present method for using ATM AAL2 switching within a wireless access gateway. This embodiment of the method has the steps of: allocating individual CIDs to transcoder channels on an as needed basis without a fixed relationship between external PVCs and transcoder channels (step 301); transcoding the call in the respective transcoder channel from a first format to a second format (step 302); and establishing a substantially even distribution of calls among the transcoders irrespective of any uneven call load on the external PVCs (step 303).

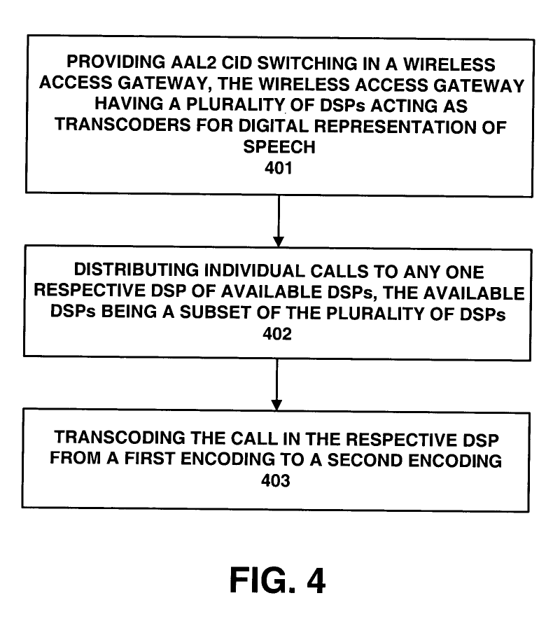

FIG. 4 depicts yet another embodiment of the present method for using ATM AAL2 switching within a wireless access gateway. This embodiment of the method has the steps of: providing AAL2 CID switching in a wireless access gateway, the wireless access gateway having a plurality of DSPs acting as transcoders for digital representation of speech (401); switching individual packets of a call to any one respective DSP of available DSPs, the available DSPs being a subset of the plurality of DSPs (402); and transcoding the packets of the call in the respective DSP from a first encoding to a second encoding (403).

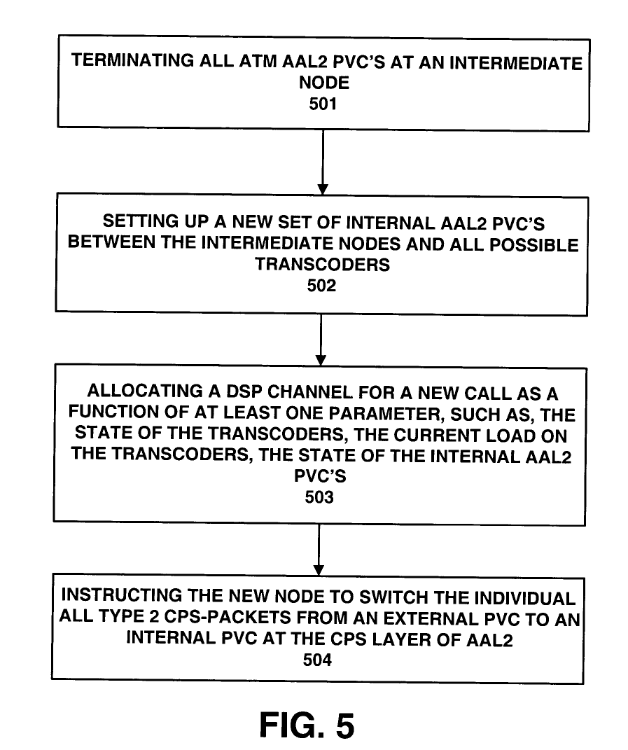

FIG. 5 depicts yet another embodiment of the present method for using ATM AAL2 switching within a wireless access gateway. This embodiment of the method has the steps of: terminating a plurality of external AAL2 PVCs at an intermediate node (step 501); setting up a set of internal AAL2 PVCs between the intermediate node and a set of transcoders that form a plurality of DSP (digital signal processor) channels (502); allocating a respective DSP channel, of the plurality of DSP channels for a call as a function of at least one predetermined parameter (503); and instructing the intermediate node to switch individual AAL TYPE 2 CPS-packets of the new call from an external AAL2 PVC of the plurality of external AAL2 PVCs to an internal PVC of the set of internal AAL2 PVCs (504).

Embodiments of the present method and system overcome the drawbacks of the prior art and provides an improved method and system in a telecommunications network for using ATM adaptation layer 2 (AAL2) switching within a wireless access gateway. With the use of AAL2 CID switching, the individual calls within the AAL2 PVCs can be handled by any transcoder within the Wireless Access Gateway. If the transcoder is out of service, there is no need to remove any PVC from service. The calls within a PVC will be handled by another transcoder within the Wireless Access Gateway.

Furthermore, embodiments of the present method and system switch packets on a per call basis at the AAL2 CPS layer resulting in very fast performance. The AAL2 SSCS layer is then terminated on a per call basis at the transcoder node.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. For example, the wireless access gateway may be utilized in UMTS, GSM, and CDMA systems. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A method for using ATM AAL2 switching within a wireless access gateway, comprising the steps of:
providing AAL2 CID (channel identifier) switching in a wireless access gateway, the wireless access gateway having a plurality of transcoders, the plurality of transcoders having a subset of transcoders that are available transcoders;
switching a call to any one respective transcoder of available transcoders; and
transcoding the call from a first format to a second format in the respective transcoder.

2. The method according to claim 1, wherein the switching of the call to any one respective transcoder of available transcoders is a function of at least one predetermined parameter, and wherein the at least one predetermined parameter comprises at least one of a state of each respective transcoder, and a current load on the plurality of transcoders.

3. The method according to claim 1, wherein the switching of the call to any one respective transcoder of available transcoders is on an as needed basis.

4. A method for using ATM AAL2 switching within a wireless access gateway, comprising the steps of:
terminating a plurality of external AAL2 PVCs at an intermediate node; setting up a set of internal AAL2 PVCs between the intermediate node and
a set of transcoders that form a plurality of DSP (digital signal processor) channels;
allocating a respective DSP channel, of the plurality of DSP channels for a call as a function of at least one predetermined parameter; and
instructing the intermediate node to switch individual AAL TYPE 2 CPS-packets of the new call from an external AAL2 PVC of the plurality of external AAL2 PVCs to an internal PVC of the set of internal AAL2 PVCs.

5. The method according to claim 4, wherein at least one predetermined parameter comprises at least one of a state of the transcoders, a current load on the transcoders, and a state of the internal AAL2 PVCs.

6. The method according to claim 4, wherein the individual AAL TYPE 2 CPS-packets of the new call from the external AAL2 PVC of the plurality of external AAL2 PVCs to the internal PVC of the set of internal AAL2 PVCs at the CPS layer of AAL2 on an as needed basis.

7. A method for using ATM AAL2 switching within a wireless access gateway, comprising the steps of:
providing AAL2 CID switching in a wireless access gateway, the wireless access gateway having a plurality of DSPs acting as transcoders for digital representation of speech;
switching individual packets of a call to any one respective DSP of available DSPs, the available DSPs being a subset of the plurality of DSPs: and
transcoding the packets of the call in the respective DSP from a first encoding to a second encoding.

8. The method according to claim 7, wherein the switching of individual packets to any one respective DSP of available DSPs is a function of at least one predetermined parameter, and wherein the at least one predetermined parameter comprises at least one of a state of the each of the transcoders, and a current load on the plurality of transcoders.

9. The method according to claim 7, wherein the switching of individual calls to any one respective DSP of available DSPs is on an as needed basis.

10. A method for using ATM AAL2 switching within a wireless access gateway, comprising the steps of:
allocating individual CIDs to transcoder channels on an as needed basis without a fixed relationship between external PVCs and transcoder channels;
transcoding the call in the respective transcoder channel from a first format to a second format; and
establishing a substantially even distribution of calls among the transcoders irrespective of any uneven call load on the external PVCs.

11. The method according to claim 10, wherein the allocating of individual CIDs to transcoder channels is a function of at least one predetermined parameter, and wherein the at least one predetermined parameter comprises at least one of a state of the each of the transcoders, and a current load on the all of the transcoders.

12. A system for using ATM AAL2 switching within a wireless access gateway, comprising:
a plurality of external AAL2 PVCs;
a plurality of internal AAL2 PVCs;
a plurality of transcoders;
at least one intermediate node operatively connected to the external AAL2 PVCs and to the internal AAL2 PVCs;
a packet switch control operatively connected to the at least one intermediate node, the plurality of internal AAL2 PVCs and the transcoders; and
wherein based upon an algorithm that takes into account at least a current state of each of the transcoders and a current load of all of the transcoders, the switch controller instructs the at least one intermediate node to switch individual AAL2 CPS-Packets from the external AAL2 PVCs to the internal AAL2 PVCs.

13. A method for using ATM AAL2 switching within a wireless access gateway, comprising the steps of:
providing AAL2 CID switching in a wireless access gateway, the wireless access gateway having a plurality of DSPs acting as transcoders for digital representation of speech;
switching individual digital representations of speech of a call to any one respective DSP of available DSPs, the available DSPs being a subset of the plurality of DSPs: and
transcoding the digital representations of speech of the call in the respective DSP from a first encoding to a second encoding.

14. The method according to claim 13, wherein the switching of individual digital representations of speech to any one respective DSP of available DSPs is a function of at least one predetermined parameter, and wherein the at least one predetermined parameter comprises at least one of a state of the each of the DSPs, and a usage level of the DSPs.

15. The method according to claim 13, wherein the switching of individual digital representations of speech to any one respective DSP of available DSPs.
